(19) United States
(12) Patent Application Publication
(10) Pub. No.: US 2023/0242130 A1
(43) Pub. Date: Aug. 3, 2023

(54) OPTIMIZED RIDER SAFETY SYSTEM

(71) Applicants: Hyundai Motor Company, Seoul (KR); Kia Corporation, Seoul (KR)

(72) Inventors: Margaux Krause, Pinckney, MI (US); Henry Teutsch, Detriot, MI (US); Amanda Christiana, Ann Arbor, MI (US); John Meyendorff, South Lyon, MI (US); John Molnar, Farmington Hills, MI (US)

(21) Appl. No.: 17/589,543

(22) Filed: Jan. 31, 2022

(51) Int. Cl. B60W 50/00; B60W 50/14; B60W 40/13; G06V 20/59

(52) U.S. Cl. CPC B60W 50/0098; B60W 50/14; B60W 40/13; G06V 20/593; B60W 2050/0083; B60W 2050/143; B60W 2050/146; B60W 2420/42

(57) ABSTRACT

Methods and systems are described for a vehicle monitoring system for detecting and mitigating rider safety risks in a vehicle. The system includes a plurality of sensors configured to collect data associated with a rider safety requirement. The rider safety requirement includes a preventative safety requirement threshold and a critical safety requirement threshold for rider safety. The system includes a controller configured to determine whether the preventative safety requirement threshold is satisfied based on the data from the plurality of sensors. In response, the controller is configured to generate a first countermeasure configured to prevent a violation of the rider safety requirement. The controller is configured to determine the critical safety requirement threshold is satisfied based on the data from the plurality of sensors. In response, the controller is configured to generate a second countermeasure configured to mitigate the violation of the rider safety requirement.

### TECHNICAL FIELD

The present disclosure relates generally to vehicles, and more particularly, to an optimized rider safety system.

### BACKGROUND

Vehicles have occupancy and weight limits to fulfill safety requirements. Typically, humans attempt to enforce occupancy and weight limits in vehicles. For example, a bus driver may evaluate when a city bus is at capacity and decline service to boarding riders or ask riders to exit the vehicle. But bus drivers cannot accurately determine when the weight limits of a vehicle have been exceeded. Further, autonomous vehicles do not have human operators to enforce occupancy and weight limits. More worrisome, autonomous vehicles do not have a protocol to enforce safety regulations in various vehicles. Currently, riders may violate safety protocols without detection by human enforcement or autonomous vehicles.

### SUMMARY

The present disclosure provides methods, systems, articles of manufacture, including computer program products, for internal combustion engine optimization.

In one aspect, there is provided a vehicle monitoring system for detecting and mitigating rider safety risks in a vehicle. The system includes a plurality of sensors configured to collect data associated with a rider safety requirement. The rider safety requirement includes a preventative safety requirement threshold and a critical safety requirement threshold for rider safety. The system includes a controller communicatively coupled to the plurality of sensors. The controller is configured to determine whether the preventative safety requirement threshold is satisfied based on the data from the plurality of sensors. In response to determining that the preventative safety requirement threshold is satisfied, generate a first countermeasure configured to prevent a violation of the rider safety requirement, the controller is configured to generate a first countermeasure configured to prevent a violation of the rider safety requirement. The controller is configured to determine the critical safety requirement threshold is satisfied based on the data from the plurality of sensors. In response to determining that the critical safety requirement threshold is satisfied, the controller is configured to generate a second countermeasure configured to mitigate the violation of the rider safety requirement.

In some variations, the first countermeasure includes at least one of summoning a second vehicle, requesting passengers to exit, reducing a vehicle speed, changing a route, and denying boarding to additional passengers, and wherein the second countermeasure includes at least one of halting vehicle movement, issuing a rider fine, and banning a rider. Additionally, the determining of whether the critical safety requirement threshold is satisfied is performed in response to generating the first countermeasure configured to prevent the violation of the rider safety requirement.

In some variations, the controller is further configured to generate a first alarm configured to alert a rider of the first countermeasure for encouraging the rider to comply with the rider safety requirement in response to determining that the preventative safety requirement threshold is satisfied. Further, the first alarm is at least one of a warning light, a notification on a display within the vehicle, a notification presented at a smartphone of the rider, and a message presented to a device of a remote operator.

In some variations, the controller is further configured to disable the first countermeasure and the first alarm based on the data from the plurality of sensors falling below the preventative safety requirement threshold, wherein disabling the first countermeasure and the first alarm is indicative of a low likelihood of the violation of the rider safety requirement. Further, the controller is further configured to generate a second alarm configured to alert a rider of the second countermeasure for encouraging the rider to comply with the rider safety requirement in response to determining that the critical safety requirement threshold is satisfied. Additionally, the second alarm is at least one of a warning light, a notification on a display within the vehicle, a notification presented at a smartphone of the rider, a message presented to a device of a remote operator, and a call to emergency services.

In some variations, the controller is further configured to disable the second countermeasure and the second alarm based on the data falling below the critical safety requirement threshold; and mark the rider safety requirement as resolved, wherein disabling the second countermeasure and the second alarm is indicative of resolving the violation of the rider safety requirement. Further, the plurality of sensors include at least one of a camera inside the vehicle for monitoring a number of passengers and a load sensor configured to detect a load on the vehicle

Implementations of the current subject matter may include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which may include a non-transitory computer-readable or machine-readable storage medium, may include, encode, store, or the like one or more programs that cause one or more processors to perform one or more of the operations described herein. Computer-implemented methods consistent with one or more implementations of the current subject matter may be implemented by one or more data processors residing in a single computing system or multiple computing systems.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 depicts an example of a flowchart for detecting and mitigating rider safety risks in a vehicle;

FIG. 2 depicts an example of a flowchart illustrating the controller detecting, mitigating, and resolving a rider safety risk;

FIG. 3 depicts an example of a block diagram illustrating an ecosystem in which rider safety risks are detected and mitigated;

FIG. 4 depicts an example of a flowchart to determine the risk of the violation of the rider safety requirement;

FIG. 5 depicts an example of a table representative of actions to be taken during low-risk situations, medium-risk situations, and high-risk situations; and

FIG. 6 depicts a block diagram illustrating a computing system consistent with implementations of the current subject matter.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiments are described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present embodiments may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium may also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” may be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

According to the present disclosure, a vehicle monitoring system may detect and mitigate rider safety risks in a vehicle. The vehicle monitoring system solves the problem of riders violating the safety rules and creating safety risks when no vehicle operator is present and the vehicle has no safety protocols. The vehicle monitoring system may detect safety risks that are imperceptible to a vehicle operator or enforcing authority. For example, the vehicle monitoring system may detect weight overloads that are otherwise imperceptible to an enforcing authority. In another example, the vehicle monitoring system may warn the riders of safety risks or conditions of which the vehicle operator may not be aware. The vehicle monitoring system may take preventative action before the safety risks escalate in severity. Additionally, the vehicle monitoring system may implement countermeasures proportional to the severity of the risks.

The vehicle monitoring system may conduct a safety check based on a combination of conditions present inside and outside the vehicle. If the safety check detects safety risks, the vehicle implements countermeasures to enforce safety measures and mitigate safety risks. The safety check may be performed by collecting data from a plurality of sensors communicatively coupled to the vehicle. Examples of the plurality of sensors may include weight sensors, seatbelt sensors, cameras, and a global positioning system. Additionally, the safety check may gather information from rider mobile devices and local infrastructure, such as traffic cameras.

Once a safety risk is detected, the vehicle monitoring system may implement a countermeasure in response to detecting a violation of a safety measure. An example of a countermeasure is reducing a vehicle speed as the vehicle capacity reaches a predetermined threshold. The vehicle monitoring system may implement a more severe countermeasure in response to continued safety violations or critical safety violations. Examples of countermeasures for critical safety violations include sounding an alarm in the bus or fining a rider.

The vehicle monitoring system presents a technical improvement by enhancing the functionality and responsiveness of autonomous vehicles. Additionally, the vehicle monitoring system is an improvement over previous vehicle safety systems as the vehicle monitoring system presented herein is tied to sensors and a controller configured to perceive risks undetectable by humans and take preventative action before the safety risks becomes critical. Additionally, the algorithm for taking preventative action is proactive rather than reactive. The algorithm is proactive by relying on at least two levels of safety thresholds and having varying degrees of preventative action to prevent violation of critical safety measures. More specifically, the vehicle monitoring system described herein includes a reminder/warning state and an alarm state. The vehicle monitoring system may determine whether rider behavior, road conditions, or weather conditions are trending towards an alarm state and issue a countermeasure accordingly (e.g., a rider smartphone notification or a notification through the vehicle speakers). Unlike the vehicle monitoring system anticipating future alarm states described herein, other vehicle safety systems only detect alarm states.

The methods, systems, apparatuses, and non-transitory storage mediums described herein detect and mitigate rider safety risks in a vehicle. The various embodiments also take actions during low-risk situations, medium-risk situations, and high-risk situations.

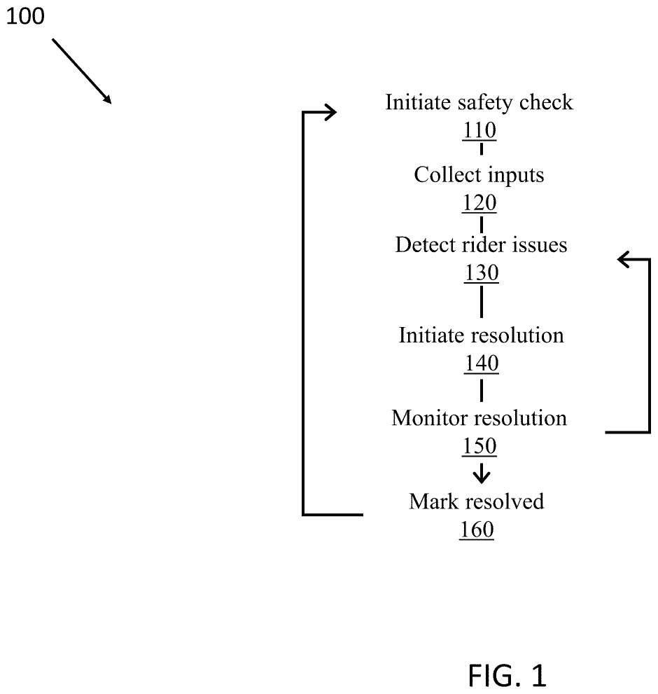

FIG. 1 depicts an example of a flowchart for detecting and mitigating rider safety risks in a vehicle. The logic of the flowchart may be implemented by a vehicle monitoring system 100. The vehicle monitoring system 100 may be configured to initiate a safety check, collect inputs from the sensors, detect activity and conditions that present risks, initiate countermeasures, monitor resolution of the risks, and mark the risks as resolved.

At 110, the vehicle monitoring system 100 may be configured to initiate a safety check of the vehicle. The safety check may be executed periodically or continuously. In particular, the vehicle monitoring system 100 may initiate a safety check in response to detecting riders in the vehicle. For example, the vehicle monitoring system 100 may be configured to detect certain types of riders in the vehicle (e.g., elderly, disabled) and initiate a safety check. The vehicle monitoring system 100 may initiate a safety check in response to inclement weather or in response to receiving a set of safety requirements.

At 120, the vehicle monitoring system 100 may be configured to collect inputs from the sensors. The sensors may be configured to collect data associated with a rider safety requirement. The rider safety requirement may include a preventative safety requirement threshold and a critical safety requirement threshold for rider safety. The sensors may include visual sensors 312, audio sensors 315, and weight sensors 318. The visual sensors 312 may be configured to detect the capacity of riders and rider behavior. In some embodiments, the visual sensors 312 may be configured to detect if the riders are social distancing, behaving obnoxiously, or making obscene gestures. Examples of visual sensors 312 may include cameras, IR cameras, LIDAR, and radar. The audio sensors 315 may be configured to detect a noise level in the autonomous vehicle. The audio sensors 315 may be configured to detect foul language, a gunshot, screaming, or calls for help. Examples of audio sensors 315 may include a microphone.

The weight sensors 318 may be configured to detect the weight of the cargo on the vehicle. For example, the weight sensors 318 may be configured to detect the weight of the luggage and the weight of the riders in the general seating section 311 and priority seating section 314 areas. The weight sensors 318 may include ultrasonic sensors, biometric sensors, vehicle door open sensors, wheel speed sensors, and tire pressure sensors.

At 130, the vehicle monitoring system 100 may be configured to detect rider activity and vehicle conditions that present risks based on the sensors. The vehicle monitoring system 100 may detect conditions satisfying a threshold associated with a preventative safety requirement. The vehicle monitoring system 100 may communicate with the plurality of sensors to determine whether the preventative safety requirement threshold is satisfied. For example, the vehicle monitoring system 100 may determine that the vehicle is near the payload limit. In another example, the vehicle monitoring system 100 may be configured to determine that the vehicle is carrying elderly passengers while traveling down a dirt road with potholes. The vehicle monitoring system 100 may be configured to detect conditions satisfying a threshold associated with a critical safety requirement. The vehicle monitoring system 100 may be configured to determine the critical safety requirement threshold is satisfied based on the data from the plurality of sensors. For example, the vehicle monitoring system 100 may be configured to determine that the vehicle exceeds its payload limit. In another example, the vehicle monitoring system 100 may be configured to determine that an elderly passenger is in distress from traveling down a dirt road with potholes.

At 140, the vehicle monitoring system 100 may be configured to initiate countermeasures to mitigate the risks. In particular, the vehicle monitoring system 100 may be configured to generate a first countermeasure configured to prevent a violation of the rider safety requirement in response to determining that the preventative safety requirement threshold is satisfied. For example, the vehicle monitoring system 100 may not accept additional cargo in order to comply with the payload requirements. In another example, the vehicle monitoring system 100 may be configured to issue a warning to the mobile devices of elderly passengers. The vehicle monitoring system 100 may be configured to generate a second countermeasure configured to mitigate the violation of the rider safety requirement. For example, the vehicle monitoring system 100 may activate an alarm light and issue a notification to riders to exit the vehicle. In another example, the vehicle monitoring system 100 may be configured to instruct the vehicle to stop to calm the elderly rider in distress.

At 150, the vehicle monitoring system 100 may be configured to monitor the resolution of the risks. The vehicle monitoring system 100 may use feedback from the sensors to determine if additional countermeasures are required. For example, the vehicle monitoring system 100 may be configured to determine whether issuing a notification to riders to exit the vehicle resulted in lowering the vehicle payload based on the weight sensor. In another example, the vehicle monitoring system 100 may be configured to determine whether the elderly rider calmed based on the audio sensors 315. The vehicle monitoring system 100 may be configured to perform an additional countermeasure if the condition or risk persists. Otherwise, at 160, the vehicle monitoring system 100 marks the risk as resolved and records the events and actions performed to a database.

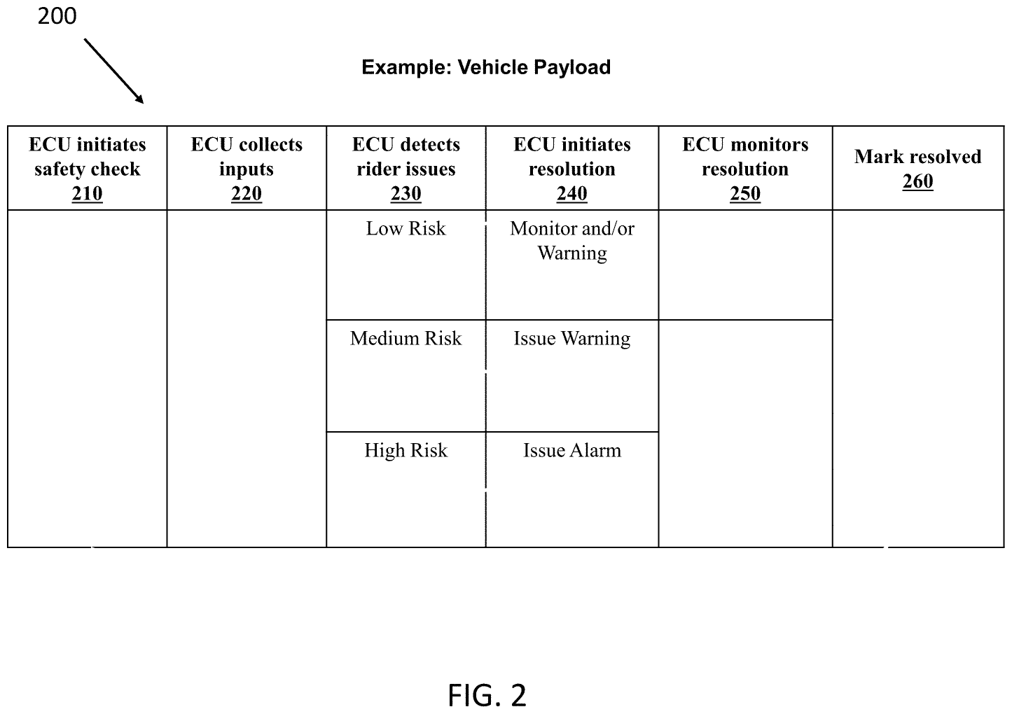

FIG. 2 depicts an example of a flowchart illustrating the controller detecting, mitigating, and resolving a rider safety requirement. The rider safety requirement may include a preventative safety requirement threshold and a critical safety requirement threshold for rider safety. A controller may be configured to determine whether the rider safety requirement is fulfilled or whether the rider safety requirement is violated. The controller may be configured to determine that a rider safety requirement is violated based on a threshold associated with the rider safety requirement is satisfied.

At 210, the controller may be configured to initiate a safety check of the vehicle. The controller may be configured to run the safety check periodically or continuously. The controller may be configured to initiate a safety check in response to detecting riders in the vehicle, a door opening or closing, or a weight sensor detecting additional passenger weight. In addition, the controller may be configured to initiate a safety check based on detecting certain types of riders in the vehicle (e.g., elderly, disabled). The controller may be configured to initiate a safety check in response to inclement weather or in response to receiving a set of safety requirements.

At 220, the controller may be configured to collect inputs from the sensors. The sensors may be configured to collect data associated with rider safety requirements. For example, the controller may be configured to collect data on the overall vehicle payload based on a weight sensor. The sensors may include visual sensors 312, audio sensors 315, and weight sensors 318. The visual sensors 312 may be configured to detect the capacity of riders, luggage size, and rider behavior. In some embodiments, the visual sensors 312 may be configured to detect if the riders are social distancing, behaving obnoxiously, or making obscene gestures. Examples of visual sensors 312 may include cameras, IR cameras, LIDAR, and radar. The audio sensors 315 may be configured to detect a noise level in the autonomous vehicle. The audio sensors 315 may be configured to detect foul language, a gunshot, screaming, or calls for help. Examples of audio sensors 315 may include a microphone. The weight sensors 318 may be configured to detect the weight of the cargo on the vehicle. For example, the weight sensors 318 may be configured to detect the weight of the luggage and the weight of the riders in the general seating section 311 and priority seating section 314 areas. The weight sensors 318 may include ultrasonic sensors, biometric sensors, vehicle door open sensors, wheel speed sensors, and tire pressure sensors.

At 230, the controller may be configured to detect rider activity and vehicle conditions that violate the safety requirements. The controller may be configured to communicate with the plurality of sensors to determine whether the preventative safety requirements are being violated or certain conditions exist. For example, the controller may be configured to determine that priority seating section 314 is occupied by persons not eligible for priority seating section 314. In another example, the controller may be configured to determine that the vehicle is transporting a criminal. The controller may be configured to detect conditions satisfying a threshold associated with a critical safety requirement. The controller may be configured to determine the critical safety requirement threshold is satisfied based on the data from the plurality of sensors. For example, the controller may be configured to determine that persons eligible for priority seating section 314 are unable to sit in the priority seating section 314. In another example, the controller may be configured to determine that the criminal has a banned item on their person.

At 240, further, the controller may be configured to initiate countermeasures to mitigate the risks. In particular, the controller may be configured to generate a first countermeasure configured to prevent a violation of the rider safety requirement in response to determining that the preventative safety requirement threshold is satisfied. For example, the controller may be configured to transmit a notification to the mobile device of the ineligible rider in priority seating section 314 to relocate to general seating section 311. In another example, the controller may be configured to issue a warning to the mobile devices of the persons sitting near the criminal. Additionally, the controller may be configured to generate a second countermeasure configured to mitigate the violation of the rider safety requirement. For example, the controller may be configured to issue a fine to the person sitting in priority seating section 314 who should give up their spot to a disabled/elderly person. In another example, the controller may be configured to instruct the vehicle to stop and alert the other riders that the criminal is carrying a banned item.

At 250, the controller may be configured to monitor the resolution of the risks. The controller may use feedback from the sensors to determine if additional countermeasures are required. For example, the vehicle monitoring system 100 may be configured to determine whether issuing a fine to ineligible persons in priority seating section 314 opened up a spot for a disabled person. In another example, the vehicle monitoring system 100 may be configured to determine that the criminal with the banned weapon has exited the vehicle. The controller may be configured to perform an additional countermeasure if the condition or risk persists. Otherwise, the controller may be configured to disable the second countermeasure and the second alarm based on the data falling below the critical safety requirement threshold. Additionally, at 260, the controller may be configured to mark the safety requirement as resolved and records the events and actions performed to a database. Disabling the second countermeasure and the second alarm may be indicative of resolving the violation of the rider safety requirement.

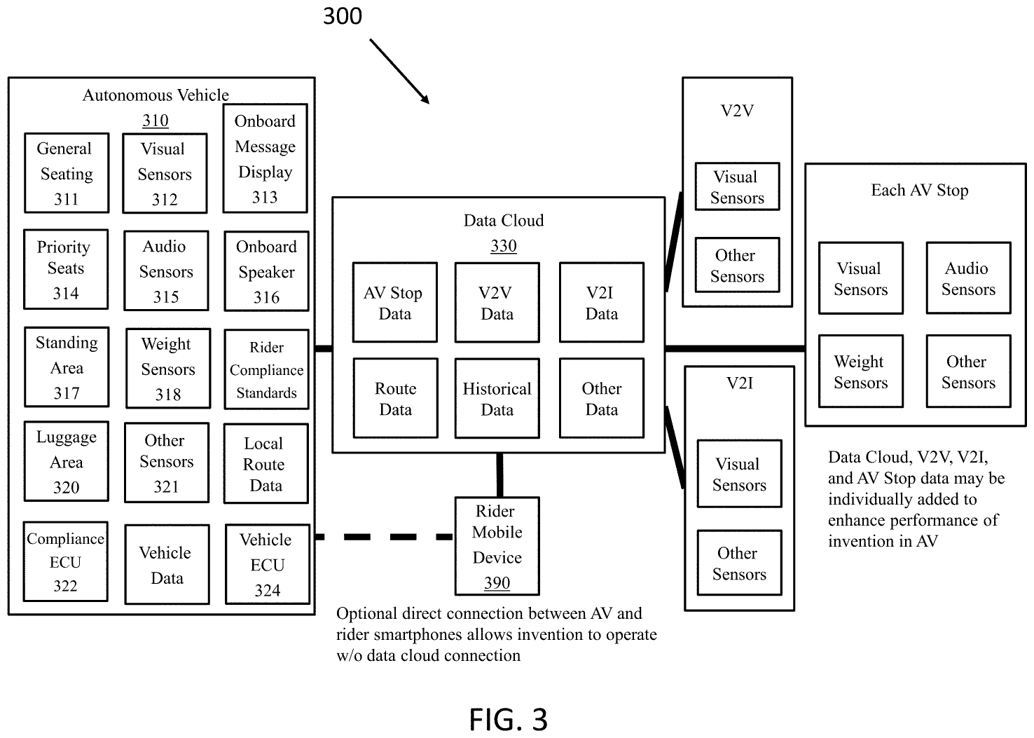

FIG. 3 depicts an example of a block diagram illustrating a vehicle ecosystem 300 in which rider safety risks are detected and mitigated. The vehicle ecosystem 300 may be capable of transporting riders, collecting data from sensors on the vehicle or outside of the vehicle, storing and referring to rider safety rules, and determining whether current conditions violate safety rules or anticipate violations of safety rules.

The vehicle ecosystem 300 may include various types of sensors. For example, the autonomous vehicle 310 may include visual sensors 312, audio sensors 315, weight sensors 318, and other sensors. The visual sensors 312 may be configured to detect the capacity of riders and rider behavior. In some embodiments, the visual sensors 312 may be configured to detect if the riders are social distancing, behaving obnoxiously, or making obscene gestures. Examples of visual sensors 312 may include cameras, IR cameras, LIDAR, and radar. The audio sensors 315 may be configured to detect a noise level in the autonomous vehicle 310. The audio sensors 315 may be configured to detect foul language, a gunshot, screaming, or calls for help. Examples of audio sensors 315 may include a microphone. The weight sensors 318 may be configured to detect the weight of the cargo on the vehicle. For example, the weight sensors 318 may be configured to detect the weight of the luggage and the weight of the riders in the general seating section 311 and priority seating section 314 areas. The weight sensors 318 may include ultrasonic sensors, biometric sensors, vehicle door open sensors, wheel speed sensors, and tire pressure sensors. The plurality of sensors may include at least one of a camera inside the vehicle for monitoring a number of passengers and a load sensor configured to detect a load on the vehicle.

The vehicle ecosystem 300 may include different outputs, such as an onboard message display 313 and an onboard speaker 316. The onboard message display 313 or an onboard speaker 316 may provide warnings or notify riders of various risks. Examples of warnings and risks may include failure to wear seatbelts, a predetermined threshold of the maximum payload capacity, maximum payload capacity, a predetermined threshold of the maximum occupancy capacity, banned items, emergency protocols, authorized riders, priority seating section 314 requirements, and a dress code.

The vehicle ecosystem 300 may include a general seating section 311, priority seating section 314 area, a standing area 317, and a luggage area 320. General seating section 311 may be seating designated for everyone. Priority seating section 314 may be designated for pregnant, elderly, and disabled persons. The luggage area 320 may include a luggage rack or overhead bin or shelf. Various sensors may be placed on the luggage rack and/or the overhead bin or shelf. Various sensors may be placed in each area to detect risks and display instructions, warnings, and risks to riders.

The vehicle ecosystem 300 may include a compliance controller 322 and a vehicle electronic control unit 324 (ECU). The compliance controller 322 may be configured to receive sensor inputs, compare sensor inputs to rider compliance standards to calculate risk levels, issue responses to risks and monitor rider resolutions. The compliance controller 322 may be configured to instruct the vehicle electronic control unit 324 to start and stop the vehicle and respond to the countermeasures generated by the compliance controller 322. The vehicle electronic control unit 324 may be configured to navigate the autonomous vehicle 310 and the scheduling of movement of the autonomous vehicle 310. In some embodiments, the compliance controller 322 and the vehicle electronic control unit 324 may be combined into the same controller 322. The controller 322 may be communicatively coupled to the visual sensors 312, the audio sensors 315, and the weight sensors 318. Additionally, the controller 322 may be communicatively coupled to the onboard message display 313 and the onboard speaker 316. The controller 322 may have access to a memory configured to store rider compliance standards, vehicle data, and local route data.

The controller 322 may be communicatively coupled to a data cloud 330. Data stored in the data cloud 330 may include AV stop data, V2V data, V2I Data, route data, historical data, and previous rider data. The V2V data may receive information from a V2V subsystem that includes visual sensors 312. The V2I data may receive data from a V2I subsystem that includes visual sensors 312. The controller 322 may be communicatively coupled to rider data cloud 390. The controller 322 may be configured to send warnings, risks, fines, and instructions to rider data cloud 390. The rider data cloud 390 may communicate directly with the autonomous vehicle 310, or it may communicate with the autonomous vehicle 310 via the data cloud 330.

The controller 322 may be configured to collect information at each vehicle stop. For example, the controller 322 may collect data from the visual sensors 312, the weight sensors 318, the audio sensors 315 at each stop along a bus route. The controller 322 may be configured to collect data from a ticket machine. Examples of data collected from the ticket machine may include a number of tickets purchased, names of persons who purchased tickets, and the times for which the tickets were purchased. The controller 322 may also be configured to collect current route and historical performance data for the route that the autonomous vehicle 310 is traveling. Additionally, the controller 322 may be configured to detect road conditions, historical traffic patterns, current weather conditions, weather forecasts, and local events that may cause delays.

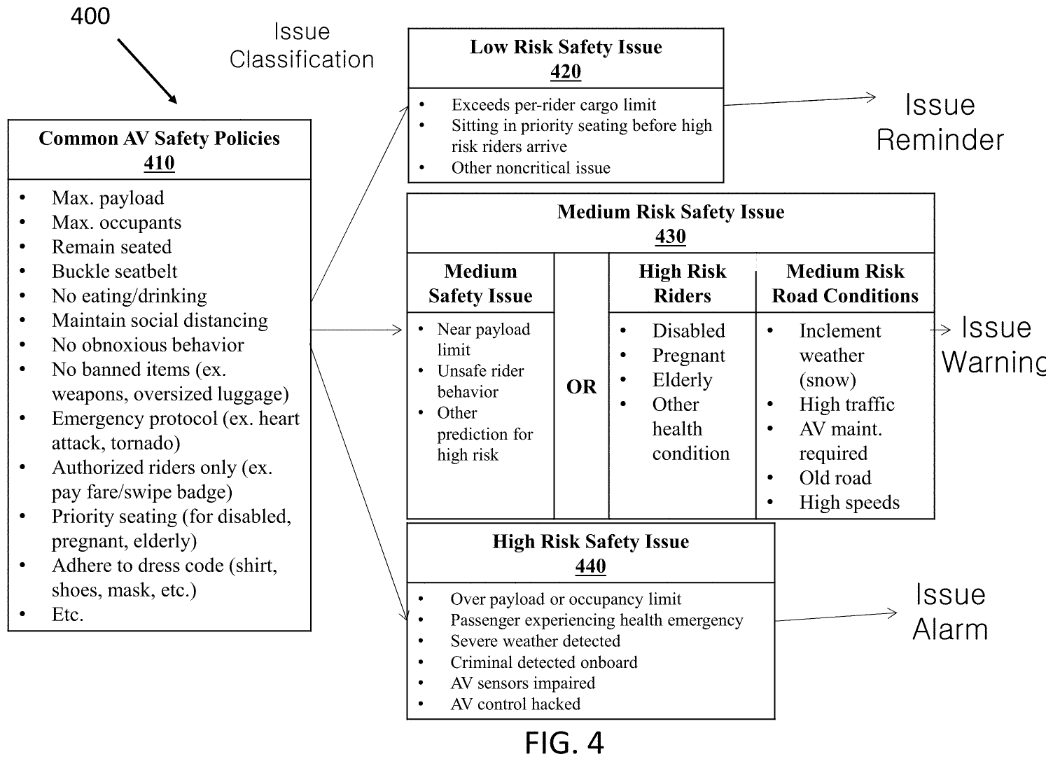

FIG. 4 depicts an example of a flowchart 400 to determine the risk of the violation of the rider safety requirement. The rider safety requirement may include a preventative safety requirement threshold and a critical safety requirement threshold for rider safety. A controller 322 may be configured to determine whether the rider safety requirement is fulfilled or whether the rider safety requirement is violated. The controller 322 may be configured to determine that a rider safety requirement is violated based on a threshold associated with the rider safety requirement is satisfied.

At 410, rider safety requirements may include a maximum payload capacity, a maximum number of allowed occupants, buckled seatbelts, social distancing, no banned items, no foul language or behavior, priority seating section 314 available for the disabled and elderly, and compliance with a dress code. In addition, rider safety requirements may have predetermined thresholds to anticipate the critical violations of the safety requirements. For example, a preventative safety requirement for a vehicle weight limit may include a predetermined threshold at about 80% of the maximum vehicle weight limit.

Rider safety requirements may be organized into low-risk safety issues 420, medium-risk safety issues 430, and high-risk safety issues 440. Low-risk safety issues 420 and medium-risk safety issues 430 may anticipate high-risk safety issues 440. Examples of low-risk safety issues 420 include an individual's baggage weight exceeds the individual baggage weight requirement and a healthy person sitting in priority seating section 314 before disabled/elderly persons arrive. Examples of medium-risk safety issues 430 include nearing the vehicle payload limit and unsafe rider behavior. Additional examples of medium-risk safety issues 430 include a combination of disabled persons in the vehicle and inclement weather, high traffic, worn-out roads, or high speeds. Examples of high-risk safety issues 440 include exceeding the vehicle payload limit, exceeding the occupancy limit, a health emergency, severe weather, a wanted criminal detected, or a malfunctioning of the autonomous vehicle 310.

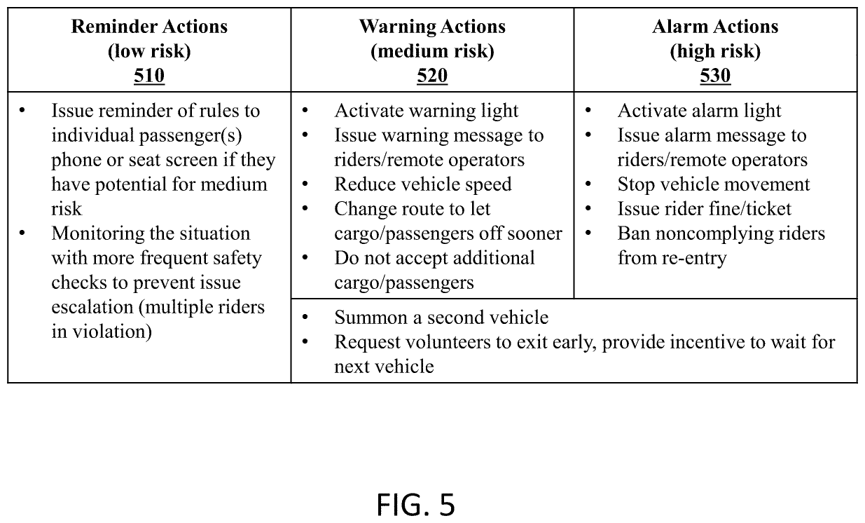

FIG. 5 depicts an example of a table representative of countermeasures to be taken during low-risk situations, medium-risk situations, and high-risk situations. Low-risk safety issues 420 and medium-risk safety issues 430 may anticipate high-risk safety issues 440. The controller 322 may be configured to implement a countermeasure for low-risk safety issues 420 and medium-risk safety issues 430 to prevent high-risk safety issues 440. The controller 322 may be configured to implement more severe countermeasures during high-risk safety issues for immediate resolution. The countermeasures may include reminder actions 510, warning actions 520, and alarm actions 530.

In response to low-risk safety issues 420 and medium-risk safety issues 430, the controller 322 may be configured to issue a first countermeasure. The first countermeasure may include summoning a second vehicle, requesting passengers to exit, reducing a vehicle speed, changing a route, and denying boarding to additional passengers. The second countermeasure may include at least one of halting vehicle movement, issuing a rider fine, and banning a rider. In some embodiments, the controller 322 may be configured to generate a first alarm configured to alert a rider of the first countermeasure for encouraging the rider to comply with the rider safety requirement in response to determining that the preventative safety requirement threshold is satisfied. The first alarm may include at least one of a warning light, a notification on a display within the vehicle, a notification presented at a smartphone of the rider, and a message presented to a device of a remote operator. In some embodiments, the controller 322 may be configured to issue a reminder or warning to devices of noncomplying persons to comply with the rider safety requirement and to devices of persons potentially affected by the noncomplying behavior.

In some embodiments, the controller 322 may be configured to disable the first countermeasure and the first alarm based on the data from the plurality of sensors falling below the preventative safety requirement threshold. The disabling of the first countermeasure and the first alarm may be indicative of a low likelihood of the violation of the rider safety requirement.

In response to high-risk safety issues 440, the controller 322 may be configured to issue a second countermeasure. For example, the controller 322 may be configured to issue an alarm to noncomplying persons to comply with the riser safety requirement. In some embodiments, the controller 322 may be configured to generate a second alarm configured to alert a rider of the second countermeasure for encouraging the rider to comply with the rider safety requirement in response to determining that the critical safety requirement threshold is satisfied. The second alarm may be at least one of a warning light, a notification on a display within the vehicle, a notification presented at a smartphone of the rider, a message presented to a device of a remote operator, and a call to emergency services. In some embodiments, the controller 322 may be configured to issue an alarm to devices of noncomplying persons to comply with the rider safety requirement and to devices of persons potentially affected by the noncomplying behavior. In some embodiments, the determining of whether the critical safety requirement threshold is satisfied may be performed in response to generating the first countermeasure configured to prevent the violation of the rider safety requirement.

In some embodiments, the controller 322 may be configured to disable the second countermeasure and the second alarm based on the data falling below the critical safety requirement threshold. The controller 322 may be configured to mark the rider safety requirement as resolved in response to the data failing below the critical safety requirement threshold. The disabling of the second countermeasure and the second alarm may be indicative of resolving the violation of the rider safety requirement.

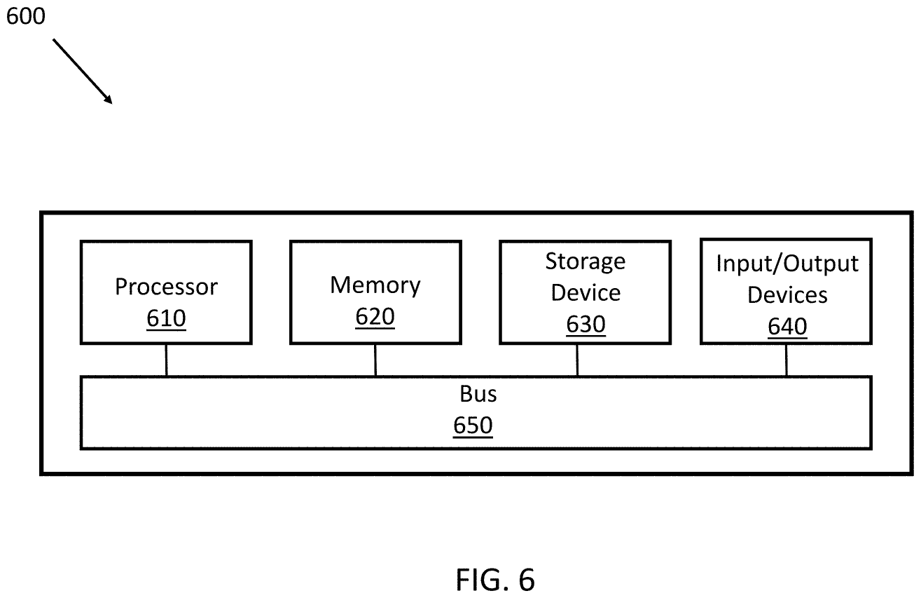

FIG. 6 depicts a block diagram illustrating a computing system 600 consistent with implementations of the current subject matter. Referring to FIGS. 1-6, the computing system 600 may be used to select between different combustion modes. For example, the computing system 600 may implement a user equipment, a personal computer, or a mobile device.

As shown in FIG. 6, the computing system 600 may include a processor 610, a memory 620, a storage device 630, and an input/output device 640. The processor 610, the memory 620, the storage device 630, and the input/output device 640 may be interconnected via a system bus 650. The processor 610 is capable of processing instructions for execution within the computing system 600. Such executed instructions may implement one or more components of, for example, optimized rider safety system. In some example embodiments, the processor 610 may be a single-threaded processor. Alternately, the processor 610 may be a multi-threaded processor. The processor 610 is capable of processing instructions stored in the memory 620 and/or on the storage device 630 to display graphical information for a user interface provided via the input/output device 640.

The memory 620 is a non-transitory computer-readable medium that stores information within the computing system 600. The memory 620 may store data structures representing configuration object databases, for example. The storage device 630 is capable of providing persistent storage for the computing system 600. The storage device 630 may be a floppy disk device, a hard disk device, an optical disk device, or a tape device, or other suitable persistent storage means. The input/output device 640 provides input/output operations for the computing system 600. In some example embodiments, the input/output device 640 includes a keyboard and/or pointing device. In various implementations, the input/output device 640 includes a display unit for displaying graphical user interfaces.

According to some example embodiments, the input/output device 640 may provide input/output operations for a network device. For example, the input/output device 640 may include Ethernet ports or other networking ports to communicate with one or more wired and/or wireless networks (e.g., a local area network (LAN), a wide area network (WAN), the Internet, a public land mobile network (PLMN), and/or the like).

In some example embodiments, the computing system 600 may be used to execute various interactive computer software applications that may be used for organization, analysis and/or storage of data in various formats. Alternatively, the computing system 600 may be used to execute any type of software applications. These applications may be used to perform various functionalities, e.g., planning functionalities (e.g., generating, managing, editing of spreadsheet documents, word processing documents, and/or any other objects, etc.), computing functionalities, communications functionalities, etc. The applications may include various add-in functionalities or may be standalone computing items and/or functionalities. Upon activation within the applications, the functionalities may be used to generate the user interface provided via the input/output device 640. The user interface may be generated and presented to a user by the computing system 600 (e.g., on a computer screen monitor, etc.).

The vehicle monitoring system presents a technical improvement by enhancing the functionality and responsiveness of autonomous vehicles. Additionally, the vehicle monitoring system is an improvement over previous vehicle safety systems as the vehicle monitoring system presented herein is tied to sensors and a controller configured to perceive risks undetectable by humans and take preventative action before the safety risks becomes critical. Additionally, the algorithm for taking preventative action is proactive rather than reactive. The algorithm is proactive by relying on at least two levels of safety thresholds and having varying degrees of preventative action to prevent violation of critical safety measures. More specifically, the vehicle monitoring system described herein includes a reminder/warning state and an alarm state. The vehicle monitoring system may determine whether rider behavior, road conditions, or weather conditions are trending towards an alarm state and issue a countermeasure accordingly (e.g., a rider smartphone notification or a notification through the vehicle speakers). Unlike the vehicle monitoring system anticipating future alarm states described herein, other vehicle safety systems only detect alarm states.

The many features and advantages of the disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

What is claimed is:

1. A vehicle monitoring system for detecting and mitigating rider safety risks in a vehicle, the vehicle monitoring system comprising:
a plurality of sensors configured to collect data associated with a rider safety requirement, the rider safety requirement including a preventative safety requirement threshold and a critical safety requirement threshold for rider safety;
a controller communicatively coupled to the plurality of sensors, the controller configured to:
determine whether the preventative safety requirement threshold is satisfied based on the data from the plurality of sensors;
in response to determining that the preventative safety requirement threshold is satisfied, generate a first countermeasure configured to prevent a violation of the rider safety requirement;
determine the critical safety requirement threshold is satisfied based on the data from the plurality of sensors; and
in response to determining that the critical safety requirement threshold is satisfied, generate a second countermeasure configured to mitigate the violation of the rider safety requirement.

2. The vehicle monitoring system of claim 1, wherein the first countermeasure includes at least one of summoning a second vehicle, requesting passengers to exit, reducing a vehicle speed, changing a route, and denying boarding to additional passengers, and wherein the second countermeasure includes at least one of halting vehicle movement, issuing a rider fine, and banning a rider.

3. The vehicle monitoring system of claim 1, wherein the determining of whether the critical safety requirement threshold is satisfied is performed in response to generating the first countermeasure configured to prevent the violation of the rider safety requirement.

4. The vehicle monitoring system of claim 1, wherein the controller is further configured to:
in response to determining that the preventative safety requirement threshold is satisfied, generate a first alarm configured to alert a rider of the first countermeasure for encouraging the rider to comply with the rider safety requirement.

5. The vehicle monitoring system of claim 4, wherein the first alarm is at least one of a warning light, a notification on a display within the vehicle, a notification presented at a smartphone of the rider, and a message presented to a device of a remote operator.

6. The vehicle monitoring system of claim 4, wherein the controller is further configured to:
disable the first countermeasure and the first alarm based on the data from the plurality of sensors falling below the preventative safety requirement threshold,
wherein disabling the first countermeasure and the first alarm is indicative of a low likelihood of the violation of the rider safety requirement.

7. The vehicle monitoring system of claim 1, wherein the controller is further configured to:
in response to determining that the critical safety requirement threshold is satisfied, generate a second alarm configured to alert a rider of the second countermeasure for encouraging the rider to comply with the rider safety requirement.

8. The vehicle monitoring system of claim 7, wherein the second alarm is at least one of a warning light, a notification on a display within the vehicle, a notification presented at a smartphone of the rider, a message presented to a device of a remote operator, and a call to emergency services.

9. The vehicle monitoring system of claim 7, wherein the controller is further configured to:
disable the second countermeasure and the second alarm based on the data falling below the critical safety requirement threshold; and
mark the rider safety requirement as resolved,
wherein disabling the second countermeasure and the second alarm is indicative of resolving the violation of the rider safety requirement.

10. The vehicle monitoring system of claim 1, wherein the plurality of sensors include at least one of a camera inside the vehicle for monitoring a number of passengers and a load sensor configured to detect a load on the vehicle.

11. A non-transitory computer-readable storage medium storing instructions for detecting and mitigating rider safety risks in a vehicle, and that when executed by a processor, cause the processor to perform operations comprising:
determining whether a preventative safety requirement threshold is satisfied based on data from a plurality of sensors configured to collect data associated with a rider safety requirement, the rider safety requirement including the preventative safety requirement threshold and a critical safety requirement threshold for rider safety;
in response to determining that the preventative safety requirement threshold is satisfied, generating a first countermeasure configured to prevent a violation of the rider safety requirement;
determining the critical safety requirement threshold is satisfied based on the data from the plurality of sensors; and
in response to determining that the critical safety requirement threshold is satisfied, generating a second countermeasure configured to mitigate the violation of the rider safety requirement.

12. The non-transitory computer-readable storage medium of claim 11, wherein the first countermeasure includes at least one of summoning a second vehicle, requesting passengers to exit, reducing a vehicle speed, changing a route, and denying boarding to additional passengers, and wherein the second countermeasure includes at least one of halting vehicle movement, issuing a rider fine, and banning a rider.

13. The non-transitory computer-readable storage medium of claim 11, wherein the determining the critical safety requirement threshold is satisfied is performed in response to generating the first countermeasure configured to prevent the violation of the rider safety requirement.

14. The non-transitory computer-readable storage medium of claim 11, wherein the operations further comprise:
in response to determining that the preventative safety requirement threshold is satisfied, generate a first alarm configured to alert a rider of the first countermeasure for encouraging the rider to comply with the rider safety requirement.

15. The non-transitory computer-readable storage medium of claim 14, wherein the first alarm is at least one of a warning light, a notification on a display within the vehicle, a notification presented at a smartphone of the rider, and a message presented to a device of a remote operator.

16. The non-transitory computer-readable storage medium of claim 14, wherein the operations further comprise:
disable the first countermeasure and the first alarm based on the data from the plurality of sensors falling below the preventative safety requirement threshold,
wherein disabling the first countermeasure and the first alarm is indicative of a low likelihood of the violation of the rider safety requirement.

17. The non-transitory computer-readable storage medium of claim 11, wherein the operations further comprise:
in response to determining that the critical safety requirement threshold is satisfied, generate a second alarm configured to alert a rider of the second countermeasure for encouraging the rider to comply with the rider safety requirement.

18. The non-transitory computer-readable storage medium of claim 17, wherein the second alarm is at least one of a warning light, a notification on a display within the vehicle, a notification presented at a smartphone of the rider, a message presented to a device of a remote operator, and a call to emergency services.

19. The non-transitory computer-readable storage medium of claim 17, wherein the operations further comprise:
disable the second countermeasure and the second alarm based on the data falling below the critical safety requirement threshold; and
mark the rider safety requirement as resolved,
wherein disabling the second countermeasure and the second alarm is indicative of resolving the violation of the rider safety requirement.

20. A method for detecting and mitigating rider safety risks in a vehicle, the method comprising:
determining whether a preventative safety requirement threshold is satisfied based on data from a plurality of sensors configured to collect data associated with a rider safety requirement, the rider safety requirement including the preventative safety requirement threshold and a critical safety requirement threshold for rider safety;
in response to determining that the preventative safety requirement threshold is satisfied, generating a first countermeasure configured to prevent a violation of the rider safety requirement;
determining the critical safety requirement threshold is satisfied based on the data from the plurality of sensors; and
in response to determining that the critical safety requirement threshold is satisfied, generating a second countermeasure configured to mitigate the violation of the rider safety requirement.
